(19) United States
(12) Patent Application Publication
(10) Pub. No.: US 2016/0008750 A1
(43) Pub. Date: Jan. 14, 2016

(54) System and Method for Cleaning of Petroleum Tanks

(71) Applicants: Michael Vanover, Keyston, IN (US); Greggory Vanover, Keyston, IN (US)

(72) Inventors: Michael Vanover, Keyston, IN (US); Greggory Vanover, Keyston, IN (US)

(21) Appl. No.: 14/326,825

(22) Filed: Jul. 9, 2014

(51) Int. Cl. B01D 35/027

(52) U.S. Cl. CPC B01D 35/027

(57) ABSTRACT

A self contained system for removing contaminants from a fluid within a reservoir, on said fluid cleaning system comprising: a fluid intake port; means for fluidically engaging said reservoir; a mechanical straining subassembly fluidically connected to said intake port; a hydraulic pump for forcing said fluid from said reservoir through said system, said pump having a motor operably connected to a vehicle engine; said pump comprising an intake port fluidically connected to said mechanical straining subassembly and an outlet port fluidically connected to a first fluid filter subassembly; said first fluid filter subassembly fluidically connected to a second fluid filter subassembly; said second fluid filter subassembly fluidically connected to a third fluid filter subassembly; said third fluid filter subassembly connected to a fluid outlet port.

### REFERENCE TO RELATED APPLICATIONS

This application claims priority from U.S. provisional patent application No. 61/956,195, the disclosure of which is hereby incorporated by reference into the present application for letters patent.

### BACKGROUND

1. Field of the Art

The present invention relates to a method and apparatus for cleaning a storage tank for petroleum products.

2. Description of the Prior Art

In industrial applications, petroleum products are typically stored in large storage tanks. These large storage tanks typically include a closed cylindrical sidewall which forms the reservoir for the petroleum products.

After prolonged use, dirt, waxes and other petroleum distillates tend to accumulate along the bottom of the storage tank. This accumulation at the bottom of the storage tank must be periodically cleaned in order to enable proper functioning of the storage tank.

There have been a number of previously known methods for cleaning the accumulation at the bottom of the storage tank.

U.S. Pat. No. 4,721,127 discloses a method and apparatus are disclosed which may be used in removing contaminants from underground petroleum storage tanks. A positive displacement pump and piping manifold are used to withdraw contaminants from an underground tank and pump those contaminants into a receiving drum. A startup suction valve is utilized to control the rate at which withdrawal is initiated and a bypass valve controls the rate of withdrawal from the tank as the cleaning operation is performed. A sample connection at the pump discharge provides means for determining the contaminant-to-product ratio of fluid being withdrawn from the underground tank. The bypass valve may be adjusted to maximize the contaminant-to-product ratio and minimize the loss of petroleum product.

U.S. Pat. No. 5,087,294 discloses a method and device for cleaning a storage tank for petroleum products of the type having a closed sidewall and a floating roof which floats upon the top of the petroleum products. Additionally, a plurality of downwardly depending legs are removably secured to the floating roof which engage the bottom of the storage tank when it is nearly empty thereby preventing the floating roof from contacting the bottom of the storage tank. The device includes an elongated nozzle having an upper end and a lower end with at least two spray jets adjacent its lower end. One of the legs is removed from the floating roof of the storage tank thereby forming an opening into which the nozzle is inserted so that its lower end is positioned adjacent the bottom of the storage tank. Thereafter, petroleum products under high pressure are pumped through the nozzle and thus through the spray jets. In doing so, the spray jets emulsify dirt, waxes, and other petroleum distillates which accumulate at the bottom of the tank. The above process is repeated for a number of spaced openings along the floating roof of the storage tank.

U.S. Pat. No. 5,111,762 discloses an apparatus for rinsing the interior of a marine engine that is attached to a boat immediately after the boat has been removed from a body of water. The apparatus is adapted to be affixed to the frame of a boat trailer in order to be carried by the boat trailer. A first reservoir holds as much fresh water as seems necessary for the cleaning job to be faced. An air tank holds compressed air and is placed in communication with the water reservoir at selected times in order to create a portable source of pressurized water. Appropriate hoses, wands, adaptors, cups, nozzles, etc., are provided for directing pressurized water that is released from the water reservoir so that the water may accomplish a flushing/rinsing job on a boat and engine and any accessories immediately after they have been removed from a lake, etc., while the engine is still hot and before any salty or foul water evaporates inside the engine. Both the water reservoir and the air tank are preferably made from pressurizable tanks of the kind commonly employed for holding liquefied petroleum gas, e.g., 40 pound butane bottles. Filling both the water reservoir and the air tank is conveniently done at a service station for automobiles or trucks, so that the boat owner does not face the expense of purchasing an air compressor or maintaining the same, etc.

U.S. Pat. No. 5,476,986 discloses a method for cleaning a mixture of air and vapour from volatile crude oil with recovery of the hydrocarbons, wherein the vapours are absorbed in an absorption means (3) by direct contact with a petroleum distillate, such as “petroleum” which has been cooled sufficiently beforehand to cause combined cooling condensation and absorption of the hydrocarbons, the petroleum distillate having a substantially constant hydrocarbon concentration is transferred from the absorption means (3) to a buffer tank (5), from which it is conveyed either to a stripping means (4) in which the hydrocarbons dissolved in the petroleum distillate are stripped so that the petroleum distillate circulates in a substantially closed circuit, or for further processing or use. Prior to absorption under pressure in the absorption means (3) the entering mixture of air and vapour is compressed in a compressor (1) and washed with crude oil under pressure in a washing column (2). The hydrocarbons recovered in the stripping means (4) are recirculated to the compressor (1). This makes it possible to recover vapours from very volatile crude oil having a high gas content in a system, which occupies less space than traditional systems and can therefore be installed e.g. on board tankers.

U.S. Pat. No. 5,488,842 discloses a method of cleaning a container having an amount of liquefied petroleum gas contained therein. The container is first inspected thoroughly for leaks. Heated nitrogen gas is then fed into the container. The heated nitrogen gas may be transported from a nitrogen storage tank to the container via at least one pipe. Liquid nitrogen may be fed into a vaporizer for vaporizing the liquid nitrogen. The nitrogen gas may then be heated via a steamer to expand the nitrogen gas and ensure that no liquid nitrogen enters the container. The heated nitrogen gas may vaporize any liquid liquefied petroleum gas contained therein. Further, the heated nitrogen gas may transport the liquefied petroleum gas to a flare for incineration. The heated nitrogen gas may be added any number of times to reduce the concentration of the liquefied petroleum gas therein to a desired level. The container may then be steam cleaned and opened to enter and thoroughly clean or inspect the inside of the container.

U.S. Pat. No. 7,594,996 discloses a system and process for recovering and/or cleaning residual or waste petroleum products such as sludge accumulated within a storage tank or upon process equipment surfaces, or from inorganic materials such as sand or clay, and the like. The system and process include a negatively charged aqueous-based dispersion fluid, which is contacted with the petroleum product under controlled relatively high pressure and high shear conditions for fluidizing hydrocarbon molecules and for preventing such molecules from adherence to process equipment surfaces, or contaminants such as sand or clay. Additional mechanical separation as by subjecting the mixed petroleum product and dispersion fluid slurry to sonic vibration may also be employed. The thus-fluidized slurry of petroleum products, dispersion fluid, and inorganic materials can be separated by conventional techniques, as by settling and/or flotation, for further individual processing and/or re-use.

However, none of the known prior art systems or methods comprise a “jetting” system and method for removing debris, water, and other contamination from petroleum products held within underground storage tanks and above ground storage tanks.

### SUMMARY

The present invention comprises, in one exemplary embodiment, a self contained system for removing contaminants from a fluid within a reservoir, said fluid cleaning system comprising: a fluid intake port; means for fluidically engaging said reservoir; a mechanical straining subassembly fluidically connected to said intake port; a hydraulic pump for forcing said fluid from said reservoir through said system, said pump having a motor operably connected to a vehicle engine; said pump comprising an intake port fluidically connected to said mechanical straining subassembly and an outlet port fluidically connected to a first fluid filter subassembly; said first fluid filter subassembly fluidically connected to a second fluid filter subassembly; said second fluid filter subassembly fluidically connected to a third fluid filter subassembly; said third fluid filter subassembly connected to a fluid outlet port.

In another exemplary embodiment, the present invention, comprises a method for cleaning a storage tank for petroleum products, said method comprising the steps of: pumping fluid to be cleaned from a fluid reservoir into a fluid filtration system; passing said fluid through a mechanical fluid straining subassembly within said system; passing said fluid through a first fluid filter subassembly within said system; passing said fluid through a second fluid filter subassembly within said system; passing said fluid through a third fluid filter subassembly within said system; forcing fluid out of said system though a fluid path of diminished area to increase the volumetric flow rate of the fluid passing through the system; and directing said cleaned fluid having increased flow rate at the inside of said reservoir to mechanically remove remaining debris therefrom.

### BRIEF DESCRIPTION OF THE DRAWINGS

The present invention will be understood more fully from the detailed description given hereinafter and from the accompanying drawings of the preferred embodiment of the present invention, which, however, should not be taken to limit the invention, but are for explanation and understanding only.

In the drawings:

FIG. 1 shows a schematic view of an exemplary system according to an embodiment of the present invention.

### DETAILED DESCRIPTION OF THE EMBODIMENTS

The present invention will be discussed hereinafter in detail in terms of the preferred embodiment according to the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessary obscuring of the present invention.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations.

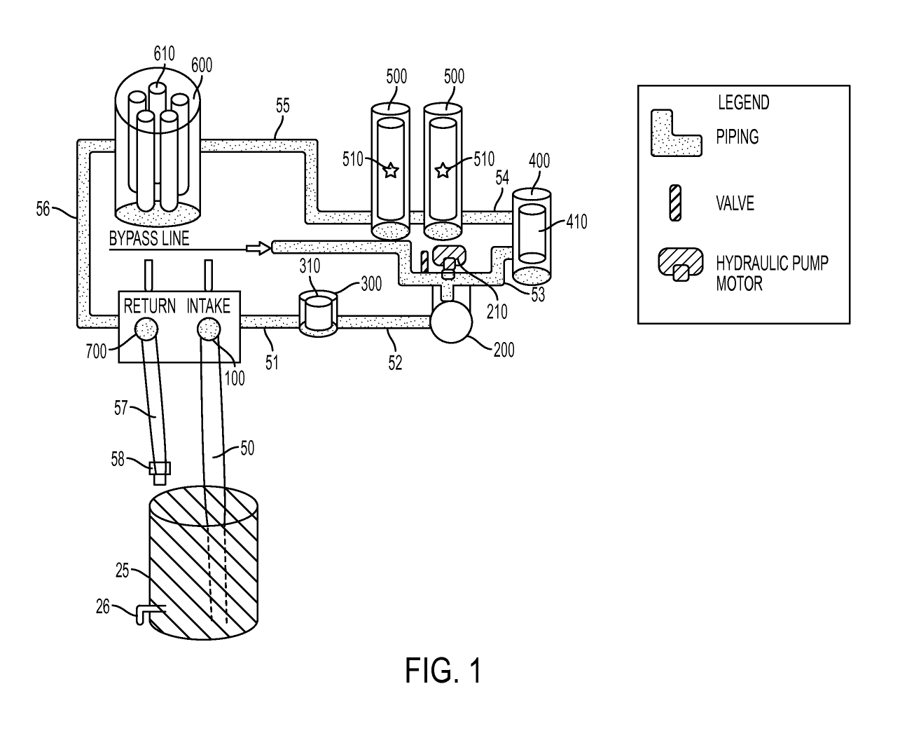

All of the implementations described below are exemplary implementations provided to enable persons skilled in the art to make or use the embodiments of the disclosure and are not intended to limit the scope of the disclosure, which is defined by the claims. In the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Referring first to FIG. 1, system 1000 of the present invention generally comprises a hydraulic pump 200; a strainer vessel 300; a bag filler vessel 400; a filtration cartridge vessel 500; and a coalescent media filter vessel 600; intake port 100 and outlet port 700, all of which are fluidically connected to one another. In the preferred embodiment of the present invention system 1000, is configured to fit within a commercial vehicle such as a the bed'of a pick-up truck, van, or small trailer. Additionally, motor 100 of pump 200 selectively connected to the vehicles engine and configured to be powered by the same.

Referring again to FIG. 1, intake port 100 is connected to a pipe or hose 50, such as hydraulic PVC piping of the type typically used in the art. Hose 50 is then inserted into a tank 25 containing a fluid from which particulates, water, or other undesired materials must be removed. Additionally, system 100 results in cleaning residual debris from the interior of tank 25. Preferably, the fluid at issue is a petroleum based fuel, lathing oil, hydraulic fluid, transmission fluid, or the like. Continuing to refer to FIG. 1, pump motor 210, powered by the vehicle engine, activates hydraulic pump 200 to create vacuum to draw fluid through hose 50 into the system 1000.

As further illustrated in FIG. 1, fluid from tank 25 is drawn through hose 50 past a shut-off valve into a strainer basket 310 within strainer basket vessel 300. An operator of system 100 makes certain that tank 25 is sufficiently full for fluid to flow into hose 50. Strainer basket 310 is steel mesh basket designed to capture large debris contained within the fluid. Strainer basket vessel 300 is fluidically connected via pipe 51 to intake port 100 and to hydraulic pump 200 via pipe 52.

Continuing to refer to FIG. 1, the fluid leaves strainer basket vessel 300 and flows via pipe 52 to and through pump 200. Pump 200 is fluidically connected to bag filter vessel 400 via pipe 53. Bag filter vessel 400 includes bag filter 410 disposed therein. Fluid from pump 200 flows into bag filter vessel 400 through bag filter 410, preferably a ten micron bag filter media.

Bag filter vessel 400 is then fluidically connected to one or more particulate filter vessels 500, each including at least one particulate filter media 510 capable of filtering debris as small as five to ten microns from a fluid.

Referring again to FIG. 1, particulate filter vessels 500 are further fluidically connected to coalescent filter vessel 600 via pipe 55. Coalescent filter vessel 600 comprises a plurality, preferably at least five, of one micron filter elements 610. Fluid from particulate filter vessels 500 enters the top of coalescent media filter 600. Via gravity and pressure, the fluid passes through filters 610. Any material that is heavier than the subject fluid (fuel) to be cleaned, falls to the bottom of the vessel where it is subsequently drained off. The cleaned fluid then exits through the top and other side of this vessel. This is to eliminate the possibility of any heavier than fuel material being returned to the tank. Cleaned fluid leaving the system is directed via pipe 56 to return port 700.

Referring again to FIG. 1, system 1000 further comprises hose 57 attached to return port 700. Hose 57 comprises a restricted linear area sized to produce fluid flow rates of preferably 3-500 gallons per minute (GPM) as cleaned “jetted” fluid passes through hose 57.

Hose 57 is preferably flexible and comprises selectively attachable nozzle 58. The jetted fluid is directed using hose 57 to the inside of tank 25 to mechanically remove (or power wash) remaining debris from the interior of tank 25.

Tank 25 further comprises one or more access ports through which samples of any fluid contained therein may be removed for visual observation of contaminants or for laboratory testing.

Those of skill in the art will appreciate that system 100 of the present invention may be used to cycle fluid through tank 25 until the fluid in tank 25 is generally free of contaminants. Alternatively, “cleaned” fluid may be jetted at debris within tank 25 to remove particulate matter from inside tank 25. Or, both methods may be used together to clean tank 25 and/or the fluid therein.

The above described process, is repeated, generally over the course of 2 to 4 hours, until tank 25 and/or the subject fluid are cleaned to the desired specifications or observable levels.

The above-described embodiments are merely exemplary illustrations set forth for a clear understanding of the principles of the invention. Many variations, combinations, modifications, or equivalents may be substituted for elements thereof without departing from the scope of the invention. It should be understood, therefore, that the above description is of an exemplary embodiment of the invention and included for illustrative purposes only. The description of the exemplary embodiment is not meant to be limiting of the invention. A person of ordinary skill in the field of the invention or the relevant technical art will understand that variations of the invention are included within the scope of the claims.

1. A self contained system for removing contaminants from a fluid within a reservoir, said fluid cleaning system comprising: a fluid intake port; means for fluidically engaging said reservoir; a mechanical straining subassembly fluidically connected to said intake port; a hydraulic pump for forcing said fluid from said reservoir through said system, said pump having a motor operably connected to a vehicle engine; said pump comprising an intake port fluidically connected to said mechanical straining subassembly and an outlet port fluidically connected to a first fluid filter subassembly; said first fluid filter subassembly fluidically connected to a second fluid filter subassembly; said second fluid filter subassembly fluidically connected to a third fluid filter subassembly; said third fluid filter subassembly connected to a fluid outlet port.

2. The system of claim 1, wherein the mechanical straining subassembly comprises a steel mesh strainer.

3. The system of claim 1, wherein the first fluid filter subassembly comprises a bag filter rated at about 5 to 10 microns.

4. The system of claim 1, wherein the second fluid filter subassembly comprises a particulate filter rated from about 5 to 10 microns.

5. The system of claim 1, wherein the third fluid filter subassembly comprises a coalescent filter device having at least five 1 micron filter elements.

6. The system of claim 1, further comprising means for selectively and forcibly directing fluid from said fluid outlet port.

7. A self contained system for removing contaminants from interior surfaces of a fluid reservoir, said reservoir cleaning system comprising: a fluid intake port; means for fluidically engaging said reservoir, a mechanical straining subassembly fluidically connected to said intake port; a hydraulic pump for forcing said fluid from said reservoir through said system, said pump having a motor operably connected to a vehicle engine; said pump comprising an intake port fluidically connected to said mechanical straining subassembly and an outlet port fluidically connected to a first fluid filter subassembly; said first fluid filter subassembly fluidically connected to a second fluid filter subassembly; said second fluid filter subassembly fluidically connected to a third fluid filter subassembly; said third fluid filter subassembly connected to a fluid outlet port; an outlet port, said outlet port fluidically connected to said third fluid filter subassembly; and a means for selectively controlling at least one of direction and flow rate of fluid from said outlet port.

8. The system of claim 7, wherein the mechanical straining subassembly comprises a steel mesh strainer.

9. The system of claim 7, wherein the first fluid filter subassembly comprises a bag filter rated at about 5 to 10 microns.

10. The system of claim 7, wherein the second fluid filter subassembly comprises a particulate filter rated from about 5 to 10 microns.

11. The system of claim 7, wherein the third fluid filter subassembly comprises a coalescent filter device having at least five 1 micron filter elements.

12. The system of claim 7, further comprising means for selectively and forcibly directing fluid from said fluid outlet port.

13. A method for cleaning interior surfaces of a fluid reservoir said method comprising the steps of: pumping fluid to be cleaned from said fluid reservoir into a fluid filtration system; passing said fluid through a mechanical fluid straining subassembly within said system; passing said fluid through a first fluid filter subassembly within said system;
passing said fluid through a second fluid filter subassembly within said system; passing said fluid through a third fluid filter subassembly within said system; forcing fluid out of said system though a return port to said reservoir; repeating said process until the fluid is sufficiently free of contamination to be suitable for its intended purpose.

14. The system of claim 13, wherein the mechanical straining subassembly comprises a steel mesh strainer.

15. The system of claim 13, wherein the first fluid filter subassembly comprises a bag filter rated at about 5 to 10 microns.

15. The system of claim 13, wherein the second fluid filter subassembly comprises a particulate filter rated from about 5 to 10 microns.

17. The system of claim 13, wherein the third fluid filter subassembly comprises a coalescent filter device having at least five 1 micron filter elements.

18. The system of claim 13, further comprising means for selectively and forcibly directing fluid from said fluid outlet port.
